(19) United States
(12) Patent Application Publication
(10) Pub. No.: US 2025/0203401 A1
(43) Pub. Date: Jun. 19, 2025

(54) Artificial Intelligence/Machine Learning Model Management Between Wireless Radio Nodes

(71) Applicant: Telefonaktiebolaget LM Ericsson (publ), Stockholm (SE)

(72) Inventors: Adrian Garcia Rodriguez, Paris (FR); Jingya Li, GÖTEBORG (SE); Daniel Chen Larsson, LUND (SE); Henrik Rydén, STOCKHOLM (SE); Mårten Sundberg, ÅRSTA (SE)

(21) Appl. No.: 18/851,235

(22) PCT Filed: Mar. 20, 2023
(86) PCT No.: PCT/SE2023/050240

§ 371 Date: Sep. 26, 2024

Related U.S. Application Data
(60) Provisional application No. 63/325,014, filed on Mar. 29, 2022.

(51) Int. Cl. H04W 24/02; H04L 41/16

(52) U.S. Cl. CPC H04W 24/02; H04L 41/16

(57) ABSTRACT

A method (1100) by a radio node (110, 210, 310) includes transmitting (1102), to another radio node (120, 220, 320), information indicating an activation or a deactivation of one or more AI and/or ML models at the radio node. For example, the radio node may include a UE and the other radio node may include a base station such that the base station is able to inform and/or suggest modifications in the node configurations to enhance communication performance and model selection at the UE.

### TECHNICAL FIELD

The present disclosure relates, in general, to wireless communications and, more particularly, systems and methods for Artificial Intelligence (AI)/Machine Learning (ML) model management between wireless radio nodes.

### BACKGROUND

Artificial intelligence (AI) and machine learning (ML) have been investigated as promising tools to optimize the design of air-interface in wireless communication networks in both academia and industry. Example use cases include using autoencoders for channel state information (CSI) compression to reduce the feedback overhead and improve channel prediction accuracy; using deep neural networks for classifying line-of-sight (LOS) and non-line-of-sight (NLOS) conditions to enhance the positioning accuracy; and using reinforcement learning for beam selection at the network side and/or the user equipment (UE) side to reduce the signaling overhead and beam alignment latency; using deep reinforcement learning to learn an optimal precoding policy for complex multiple-input multiple-output (MIMO) precoding problems.

In 3GPP New Radio (NR) standardization work, there is a new Release 18 study item (SI) on AI/ML for NR air interface. See, RP-213599, “Study on Artificial Intelligence (AI)/Machine Learning (ML) for NR Air Interface”, December 2021. This study item will explore the benefits of augmenting the air-interface with features enabling improved support of AI/ML based algorithms for enhanced performance and/or reduced complexity/overhead. Through studying a few selected use cases such as, for example, CSI feedback and beam management and positioning, this SI aims at laying the foundation for future air-interface use cases leveraging AI/ML techniques.

When applying AI/ML on air interface use cases, different levels of collaboration between network nodes and UEs can be considered:
No collaboration between network nodes and UEs: In this case, a proprietary ML model operating with the existing standard air interface is applied at one end of the communication chain (e.g., at the UE side). And the model life cycle management (e.g., model selection/training, model monitoring, model retraining, model update) is done at this node without inter-node assistance (e.g., assistance information provided by the network node).
Limited collaboration between network nodes and UEs: In this case, a ML model is operating at one end of the communication chain (e.g., at the UE side), but this node gets assistance from the node(s) at the other end of the communication chain (e.g., a gNB) for its AI model life cycle management (e.g., for training/retraining the AI model, model update).
Joint ML operation between network notes and UEs: In this case, it may be assumed that that the AI model is split with one part located at the network side and the other part located at the UE side. Thus, the AI model requires joint training between the network and UE, and the AI model life cycle management involves both ends of a communication chain.

It is considered that multiple proprietary ML and non-ML models/functionalities are placed at the UE and network sides.

Building an AI model includes several development steps where the actual training of the AI model is just one step in a training pipeline. An important part in AI developing is the ML model lifecycle management. FIG. 1 illustrates example training and interference pipelines and their interactions within a model lifecycle management. Specifically, as depicted, the AI model lifecycle management typically consists of:
A training (re-training) pipeline,
   With data ingestion referring to gathering raw (training) data from a data storage. After data ingestion, there may also be a step that controls the validity of the gathered data.
   With data pre-processing referring to some feature engineering applied to the gathered data, e.g., it may include data normalization and possibly a data transformation required for the input data to the AI model.
   With the actual model training steps as previously outlined.
   With model evaluation referring to benchmarking the performance to some baseline. The iterative steps of model training and model evaluation continues until the acceptable level of performance (as previously exemplified) is achieved.
   With model registration referring to register the AI model, including any corresponding AI-meta data that provides information on how the AI model was developed, and possibly AI model evaluations performance outcomes.
A deployment stage to make the trained (or re-trained) AI model part of the inference pipeline.
An inference pipeline,
   With data ingestion referring to gathering raw (inference) data from a data storage.
   With data pre-processing stage that is typically identical to corresponding processing that occurs in the training pipeline.
   With model operational referring to using the trained and deployed model in an operational mode.
   With data & model monitoring referring to validate that the inference data are from a distribution that aligns well with the training data, as well as monitoring model outputs for detecting any performance, or operational, drifts.
A drift detection stage that informs about any drifts in the model operations.

Relevant state-of-the-art includes the network being able to select the UEs that utilize AI/ML models. See, Intel corporation, “High level principle and Functional Framework of AI/ML enabled NG-RAN Network,” R3-213468, 3GPP TSG-RAN WG3 Meeting #113-e, August 2021.The network could perform such selection based on a) the UE QoS, b) RAN measurement results, c) indications from the core network or the UE itself.

There currently exist certain challenge(s), however. For example, although the network may be able to control the UEs that utilize AI/ML, this is at the coarsest level of control and will not be able to capture an understanding of aspects relating to AI/ML model Life-Cycle Management (LCM).

### SUMMARY

Certain aspects of the disclosure and their embodiments may provide solutions to these or other challenges. For example, methods and systems are provided that introduce communication between radio nodes in the network to allow the management of models implemented at the UE and/or the network.

According to certain embodiments, a method by a second radio node includes transmitting, to a first radio node, information indicating an activation or a deactivation of one or more AI and/or ML models at the first radio node.

According to certain embodiments, a second radio node is adapted to transmit, to a first radio node, information indicating an activation or a deactivation of one or more AI and/or ML models at the first radio node.

According to certain embodiments, a method by a first radio node includes transmitting, to at least one other radio node, information for triggering an activation or a deactivation of one or more AI and/or ML models for implementation at the at least one other radio node.

According to certain embodiments, first radio node is adapted to transmit, to at least one other radio node, information for triggering an activation or a deactivation of one or more AI and/or ML models for implementation at the at least one other radio node.

Certain embodiments may provide one or more of the following technical advantage(s). For example, certain embodiments may provide a technical advantage of allowing an optimized model selection based on a variety of criteria including such as, for example, received signal quality and/or node operating conditions (e.g., energy state of the UE).

As another example, certain embodiments may provide a technical advantage of enabling the network to inform and/or suggest modifications in the node configurations to enhance communication performance (e.g., number of DMRSs when a specific set of models is active) based on the model selection.

As still another example, certain embodiments may provide a technical advantage of enabling performance supervision of one or more models utilized for the communication between two wireless nodes. The supervision ensures robust network operation by avoiding uncontrolled model behavior in the network.

As yet another example, certain embodiments may provide a technical advantage of enabling the identification of the need of model re-training, where further actions can be taken for such re-training.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates example training and interference pipelines and their interactions within a model lifecycle management;

FIG. 2 illustrates an example flowchart including signaling for efficient AI/ML model management between two nodes in a wireless network, according to certain embodiments;

FIG. 3 illustrates example signaling enabling a transmitter to suggest activation of two models for comparison, according to certain embodiments;

FIG. 4 illustrates another example of signaling enabling a transmitter to suggest activation of two models for comparison, according to certain embodiments;

FIG. 5 illustrates an example communication system, according to certain embodiments;

FIG. 6 illustrates an example UE, according to certain embodiments;

FIG. 7 illustrates an example network node, according to certain embodiments;

FIG. 8 illustrates a block diagram of a host, according to certain embodiments;

FIG. 9 illustrates a virtualization environment in which functions implemented by some embodiments may be virtualized, according to certain embodiments;

FIG. 10 illustrates a host communicating via a network node with a UE over a partially wireless connection, according to certain embodiments;

FIG. 11 illustrates a method by a second radio node, according to certain embodiments;

FIG. 12 illustrates a method by a first radio node, according to certain embodiments;

FIG. 13 illustrates another method by a first radio node, according to certain embodiments;

FIG. 14 illustrates another method by a second radio node, according to certain embodiments

FIG. 15 illustrates another method by a first radio node, according to certain embodiments

FIG. 16 illustrates another method by a first radio node, according to certain embodiments

FIG. 17 illustrates a method by a network node, according to certain embodiments; and

FIG. 18 illustrates a method by a UE, according to certain embodiments.

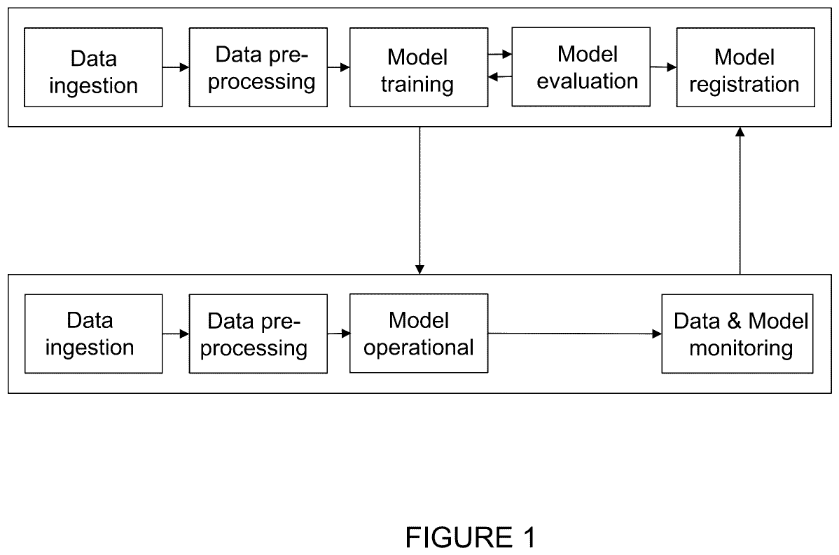

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station, multi-standard radio (MSR) radio node such as MSR base station, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS). Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point. Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

According to previous systems and techniques, the network may be able to control the UEs that utilize AI/ML, but this control is at the coarsest level and will not be able to capture an understanding of aspects relating to AI/ML model Life-Cycle Management (LCM)., e.g., understanding overall model performance in the field and adapting model usage confidently in network operation—which requires an effectively using the models available. This includes aspects on understanding how models perform on out-of-distribution data, how to act in cases where models “misbehave”, and ensuring that models not performing as expected do not have a detrimental impact to network performance. According to certain embodiments described herein, however, methods and systems are provided to support and communicate the configuration of models, including activation/deactivation at the UE and/or the network. As used herein, the term model may refer to an ML-based model, a configuration of an ML-based model, a non-ML-based functionality, or a configuration of a non-ML-based functionality. A network may refer to one of a generic network node, a gNB, a base station, a unit within the base station to handle at least some ML operation, a relay node, a core network node, a core network node that handle at least some ML operations, or a device supporting D2D communication. A model may be active-utilized for communication-related or performance evaluation purposes-or inactive.

Two different main signaling procedures are described herein to support efficient AI/ML model management:
Requesting suggesting model activation deactivation: The signaling takes place between a primary node (transmitting node) and a secondary node (receiving node). This provides the necessary means for the transmitting node to configure/activate or deactivate models or other configurations at the receiving node based on certain conditions being fulfilled. Each model can further be configured with a different purpose such as, for example, for evaluating the performance of the model.
Notification of model activation deactivation: The signaling takes place from a primary node (transmitting node) and a secondary node (receiving node). This provides the necessary means for the transmitting node to configure/activate or deactivate models or other configurations based on certain conditions being fulfilled. Each model can further be configured with a different purpose such as, for example, for evaluating the performance of the model.

The model signaling procedures are described below using explicit fields in intended message used for configuration/notification. It should be understood that such a message might not contain such explicit fields in a specification text. It should further be noted that the functionality supported by the different fields in signaling procedures may be included in a single message, and need not all be explicitly signaled between the two wireless nodes but could also be part of specification text.

According to certain embodiments, for example, methods and systems are provided to address the limitations discussed above so as to allow AI/ML model management in terms of, for example, supervision of model performance (understanding how well models perform in the network) and/or tailored performance to specific conditions (e.g., using different models depending on energy level in the executing node or received signal quality). Specifically, these objectives may be achieved by introducing communication between radio nodes in the network to allow the management of models implemented at the UE and/or the network. The communication outlined in certain embodiments described herein enables, e.g., performance monitoring of configured models.

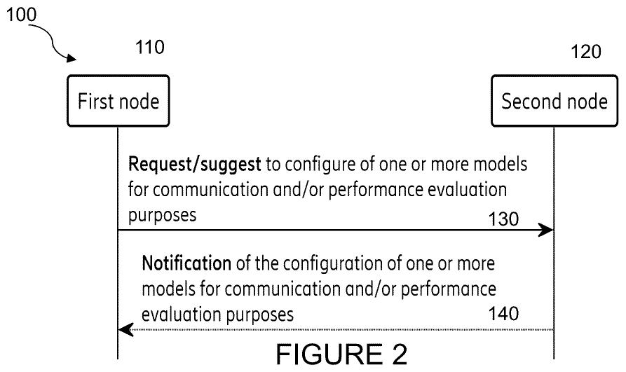

FIG. 2 illustrates example signaling 100 for efficient AI/ML model management between two nodes in a wireless network, according to certain embodiments. Specifically, FIG. 2 demonstrates communication support between a first node 110 and a second node 120 that includes:
1) at step 130, requesting/suggesting the configuration (e.g., the activation/deactivation) of specific models for communication and/or performance evaluation purposes at the second node 120; and
2) at step 140, notifying the first node 110 of the configuration (e.g., activation/deactivation) of specific models for communication and/or performance evaluation and/or communicate and/or suggest modifications in the configurations as a result of the model activation/deactivation.

In a particular embodiment, the first node 110 includes a radio node that controls the ML model management and the second node 120 includes a radio node that will consider the request/suggestions on ML model configurations provided by the first node 110. In some embodiments, only one of the depicted signaling messages (request/suggest message or notification message) may be transmitted.

In a particular embodiment, the configuration may specify a set of condition(s) that should or will be evaluated to activate/deactivate the specified models for communication and/or performance evaluation purposes at the primary or secondary node. In addition, such configuration may also specify:
a) the set of conditions to activate/deactivate models for communication-related purposes depending on the result of the performance evaluation, and/or
b) a modified configuration that may be implemented as a result of the model activation/deactivation.

### Model Activation Deactivation Request Suggestion Signaling

According to certain particular embodiments, the model activation/deactivation request/suggestion signaling may include at least one of the following information fields:
1) Model ID field: Comprising the model(s) ID to deactivate/activate by the receiving node.
   For some use cases, the model ID can be inexplicitly indicated by a new UE capability that is linked to this model, or by a new report type that is associated to this model. The model ID could also be a reference just to functionality that would be implemented in part with a AI/ML based model.
2) Functionality area ID field: Comprising the functionality area ID of the model(s) to activate/deactivate by the receiving node, which characterizes the purpose of the model ID, e.g., channel estimation, decoding, etc.
   For some use cases, there may be multiple models associated to the same functionality area ID. In this case, if no specific model ID is indicated, the receiving node may activate/deactivate all models that are associated to the received functionality area ID, or the receiving node may activate/deactivate all models that are associated to the received functionality area ID except for a default/fallback model.
3) Activate deactivate field: Indicating whether the specified model(s) in the model ID field are to be activated or deactivated.
4) Condition field: Comprising a set of condition/s to that should be evaluated to activate/deactivate/swap the specified model(s).
   Additionally, in a particular embodiment, an alternative model to be activated/deactivated when a specific condition or set of conditions are satisfied may be specified.
5) Purpose field: Determining whether the activation/deactivation request/suggestion is performed for a) communication-related, or b) performance evaluation/model retraining purposes.
   In such case, the signaling may include additional information for configuring the performance evaluation. This information may include the set of conditions to trigger a performance evaluation and/or to activate/deactivate model(s) for communication-related purposes depending on the result of the performance evaluation. This may differ from previous systems because the node receiving the activation/deactivation request/suggestion signaling does not necessarily need to report the output of such performance evaluation.
6) Detailed model configuration field: Comprising detailed model configuration parameters, which may include one or more of, for example:
   the frequency bands/carriers/cells/timing advance groups (TAGs) where a model is to be activated/deactivated;
   the period of time during which a model is to be activated/deactivated; and
   the indication of whether a response message is expected.
7) Detailed configuration field: Comprising information on:
   additional request/suggestion changes in the configuration of other models or functionalities at the receiving node upon activation/deactivation of the specified models, and/or
   the changes in the configuration of other models or functionalities at the transmitting node following the expected activation/deactivation of the specified models.

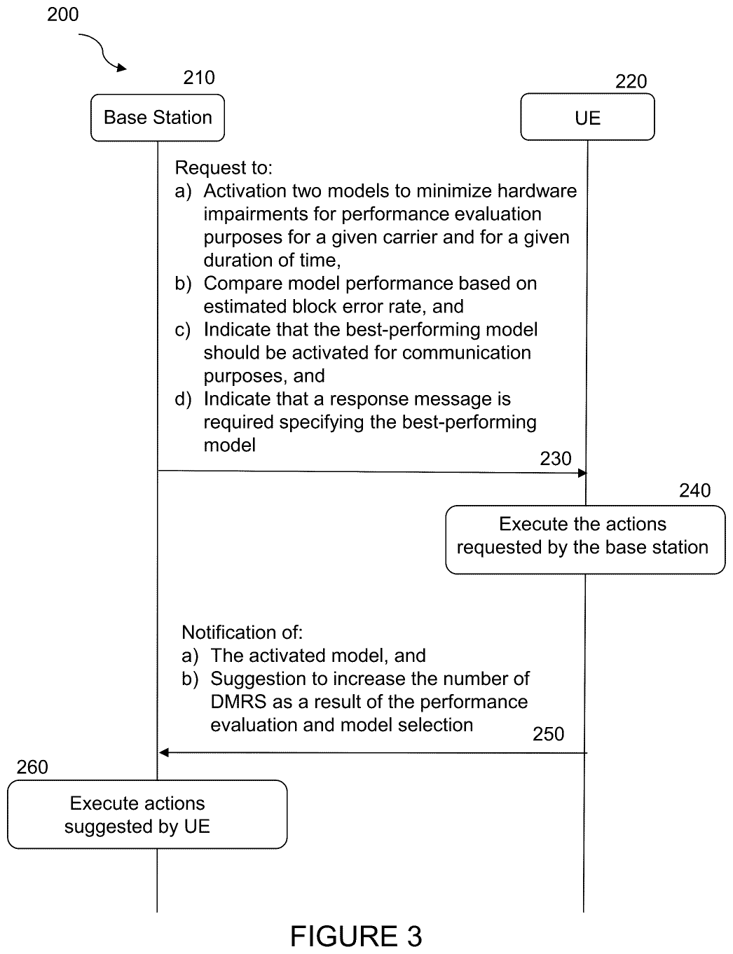

For instance, FIG. 3 illustrates example signaling enabling a transmitter of the signaling to suggest an activation of two models/functionalities (e.g., ML- and non-ML-based) at the receiver of the signaling for comparison of the performance of the models so that the most adequate model may be utilized afterwards. Specifically, FIG. 3 demonstrates example communication support between a base station 210 and a UE 220.

At step 230, the base station 210 sends, to the UE 220, a request/suggestion of a configuration (e.g., the activation/deactivation) of one or more specific AI/ML models for communication and/or performance evaluation purposes. For example the message may request/suggest activation of two models for performance evaluation purposes for the purpose s of minimizing hardware impairments. In a particular embodiment, the request/suggestion may be for a given carrier and for a given time duration. As another example, the request/suggestion may request the UE 220 to compare model performance based on an estimated block error rate. As still another example, in particular embodiments, the request/suggest may indicate that the best-performing model should be activated for communication purposes and/or that a response message is required. At step 240, UE 220 may execute the actions requested by the base station 210.

At step 250, the UE 220 may send a message to the base station 210 that provides notification of an activation of the one or more model(s). Additionally or alternatively, the message may suggest that base station 210 increase or decrease a number of DMRSs as a result of the performance evaluation and model selection performed by the UE 220.

At step 260, the base station 210 may execute the actions suggested by UE 220.

In particular embodiments, the activation/deactivation request/suggestion signaling depicted in FIGS. 2 and 3 may be by unicast message(s), multicast message(s), or broadcast message(s). In further particular embodiments, the messages may be signaled as RRC messages. MAC CE messages, random-access messages, or as L1 messages. A message maybe sent from the network to the UE or the other way around. The L1 message may, for example, be in a Downlink Control Information (DCI) format or a sidelink control information (SCI) format.

In a particular embodiment, to the receiving node may identify that the message is a model activation/deactivation request/suggestion message based on an RNTI that is specific for this purpose. Likewise, other fields in a DCI/SCI format that can be used for other purposes may be set in a manner to identify that the message is a model activation/deactivation request/suggestion message. In another embodiment, a specific size in number of bits or a specific search space for PDCCH/PSCCH carrying the DCI/SCI may be used to indicate that the message is a model activation/deactivation request/suggestion message.

In still another example embodiment, the L1 message can be a random-access preamble or an uplink control information (UCI) message that is specifically designed for indicating the activation/deactivation request/suggestion, or/and transmitted in specific radio resources associated to this purpose. If the message is a MAC CE, for example, the message may be identified by a specific eLCID or by a specific field contained in the MAC CE.

Further, in various particular embodiments, it may be that there are separate messages defined for each of the activation request, deactivation request, activation suggestion, and deactivation suggestion.

According to particular embodiments, the configuration message described herein may configure the UE per cell, bandwidth part (BWP), TAG or/and cell group. Each configuration may have a different instance of the model and by that further separate activation/deactivation of the model.

In some particular embodiments, the model activation/deactivation request/suggestion signaling may be an independent message. In other embodiments, the model activation/deactivation request/suggestion signaling may be part of other messages.

### Condition Field

In certain particular embodiments, where the condition field is not empty, the conditions that should be evaluated to activate/deactivate/swap the specified model(s) may refer to, for example:
a) Changes in the active/inactive model(s) at the same or a different node.
   For instance, the receiving node may be configured to activate/deactivate a different model depending on the active model selected by the transmitting node.
b) Network-related conditions (e.g., cell/carrier/BWP activation/deactivation).
   For example, if the transmitting node is a base station, the condition field may indicate the model the UE should utilize when the UE is dual-connected.
   As another example, if the transmitting node is a base station, the condition field may indicate the model the UE should utilize depending on the selected BWP.
      For example, the signaling may be defined in an RRC message per BWP, cell, carrier, PUCCH cell group, TCI state, and so on. When the UE receives a message or a trigger that changes, for example, BWP, activation of carrier or cell, activation of TCI state, etc., the UE may, at the same time, apply the described condition and, by that, either then activate or deactivate model that is associated with the configuration. One should note here that the message indicating a change in for example BWP, activation of carrier or cell, activation of TCI state, etc. can in addition also be an MAC CE or DCI message.
c) Type/s of wireless traffic (i.e., QoS, access identity, access category, network slice) of the communication.
   For example, if the transmitting node is a base station, the condition field may indicate the model the UE should utilize when transmitting uplink traffic with certain QoS Class Identifiers (QCIs), 5QIs (5G QOS Identifiers), access identities/categories, or network slices.
   As another example, the receiving node may be asked to utilize the best-performing model upon detecting the reception of downlink traffic with certain QCIs/5QIs. The model may be subsequently deactivated after a specified period of time with where the traffic with the most stringent model requirements is not received.
d) Signal-dependent conditions (e.g., serving/interfering RSRPs, SINRs above/below a given threshold, used reference signal pattern, e.g., number of symbols that contain DMRS in time and/or in frequency or a DMRS pattern type, or LoS/NLOS channel conditions).
   For example, if the transmitting node is a base station, the condition field may indicate capable UEs to implement the ML-based model, offering the best performance when the RSRP is below a given value, which may intuitively characterize the cell edge for the cell covered by the base station.
   As another example, if the UE is scheduled with PDSCH with a specific DMRS pattern, the UE may use a certain ML-model within its receiver chain and, if it is scheduled with another DMRS pattern, the UE may use another ML-model. The DMRS pattern can, for example, be given by the number symbol of DMRSs within the PDSCH, where the first DMRS symbol within the PDSCH is located, e.g., if it is located in the first symbol or not or the frequency density of the DMRS for PDSCH.
   As still another example, if the transmitting node is a base station, the condition field may indicate the capable UEs that are under LoS channel conditions (with a certain probability that is signalled) to activate the ML-based model for CSI reporting to reduce the CSI feedback overhead. A LOS and NLOS classifier can be implemented at the network side to enable the base station making decisions on sending such signaling.
   For example, if the UE experience a large variation in its RSRQ/SINR over a certain time duration, the UE may activate a model capable of forecasting potential interference.
e) UE-dependent conditions (e.g., based on the battery level or the mobility of the device)
   For example, if the transmitting node is a base station, the condition field may indicate UEs to activate a model if the battery level is below a certain threshold. For instance, this may allow the UE to save energy while using an ML model instead of legacy procedure by, e.g., predicting a measurement instead of measuring.
   As another example, if the transmitting node is a base station and the base station determines that the wireless channel varies at a very low rate, the base station may indicate the UE to activate an ML model to learn its environment and adapt its radio operations to said environment. In another example, a highly mobile UE may activate a mobility predictor, in order to improve future, inter/intra-handover decisions.

In some embodiments where condition information fields are not empty, the transmitter may indicate the period of time during which the set of conditions specified are applicable.

In some embodiments where the activation/deactivation of the model(s) is performed for performance evaluation purposes and the condition information fields are not empty, the condition information field may include additional information specifying the criteria to activate/deactivate models depending on the result of the performance evaluation. Such conditions depend on the specific method for performance evaluation, for example:
1) For cases where the performance evaluation consists in evaluating and/or comparing the performance of one or a multiplicity of models, the conditions may include, for example:
   a selection of the best-performing model,
   a selection of the less power-consuming model that is above a given performance threshold,
   a selection of the model capable of including epistemic uncertainty (e.g., that is, the uncertainty due to the lack of training data in a certain input feature region), and/or
   a selection of the model that has explainability (e.g., a model capable of producing a SHapley Additive explanations (SHAP) values).
2) for cases where the performance evaluation consists in the identification of the presence of out-of-distribution input data to an ML-based model, e.g.,
   utilize a non-ML functionality if the input data is identified to be out-of-distribution.

In some particular embodiments where the model activation/deactivation request/suggestion signaling is part of other messages, the conditions may be implicitly related to the configuration being performed for such messages. For instance, if the transmitting node is a base station transmitting a message to configure a given BWP, such message may include at least the model ID field specifying the models to be utilized by the UE when utilizing such BWP.

### Purpose field

In some embodiments where the purpose field indicates that the model activation/deactivation is performed for performance evaluation purposes, the purpose field may include information on the method(s) that should be executed during a given performance evaluation. For example, the performance evaluation may be based on one or more of:
a) one or more methods to estimate the accuracy of a given model,
b) one or more methods to identify the presence of out-of-distribution input data to an ML-based model,
c) a comparison between i) the outputs obtained by a model when using known/training information against ii) the known expected/ideal outputs that should obtained by a well-functioning model.

In some embodiments where the purpose field activation/deactivation of the model(s) indicates that the activation/deactivation is performed for performance evaluation purposes and the condition information fields are not empty, the condition information field may include additional information specifying when to trigger a model performance evaluation. For example, conditions to trigger a model performance evaluation may comprise one or more of:
1) The utilization of the model in a new setup.
   For example, in the case of a UE model, the new model may be used after the initial access procedure, after the handover to a new cell, after activation/deactivation of a network or UE model, and/or after a new network or UE model becomes available.
   As another example, in the case of a network model, the new model may be used after activation/deactivation of a network or UE model, after a new network or UE model becomes available.
2) Reaching a certain level of performance degradation in the communication link.
3) Continuously.

In some embodiments where the Purpose field activation/deactivation of the model(s) indicates that the activation/deactivation is performed for communication-related purposes, the activation/deactivation request/suggestion signaling may only indicate the model to activate, since the receiving node will implicitly have knowledge of the model to deactivate (i.e., the model currently active for communication-related purposes).

In some particular embodiments, the purpose field may indicate whether the receiving node should mandatorily request or optionally suggest activation/deactivation of the specified models.

### Detailed Model Configuration Field

The detailed model configuration field may include information on one or more of:
The frequency bands/carriers where a model is to be activated/deactivated.
   For example, if the communication is simultaneously carried out via a low-frequency carrier (e.g., sub-6 GHz) and a high-frequency carrier (e.g., mmWave), an ML-based model focused on dealing with hardware impairments may be activated only for the high-frequency carrier.
   As another example, if the communication is simultaneously carried out via a low-frequency carrier (e.g., sub-6 GHz) and a high-frequency carrier (e.g., mmWave) and the low-throughput reliability-sensitive traffic is only transmitted via the low-frequency carrier, a high-performing ML-based model may be activated only for the low-frequency carrier.
The period of time a model is to be activated/deactivated.
   For example, the receiving node may be asked to activate the model(s) for a predetermined duration of time, e.g., when the model is activated for performance evaluation purposes.
   As another example, the receiving node may be asked to activate a model from a given point in time and until further notice.
   As still another example, the transmitting node may specify the period time depending on the allowed alternatives defined in the specification text.
The indication of whether a response message is expected.
   In some particular embodiments, the node receiving the activation/deactivation request/suggestion signaling may not signal a response to the node that transmitted the activation/deactivation request/suggestion signaling. Such lack of response may be interpreted by the node that transmitted the activation/deactivation request/suggestion signaling either as an implicit acceptance or rejection of the request/suggestion. The choice of one interpretation may be based on previous configuration signaling or specification text.
   In some particular embodiments, the node receiving the activation/deactivation request/suggestion signaling may signal a response to the node that transmitted the activation/deactivation request/suggestion signaling. In some embodiments, such response may only include a single bit indicating whether the model activation/deactivation request/suggestion previously received has been implemented. In other embodiments, such response may adopt the form of the signaling described below.

### Detailed Configuration Field

The detailed configuration field may include information on one or more of:
Additional request/suggestion changes in the configuration of other models or functionalities at the receiving node upon activation/deactivation of the specified models.
   For example, if the transmitting node is a base station, the signaling may indicate to the receiver to change its uplink power control configuration as a result of activating/deactivating a model related to data transmission at the transmitting node.
The changes in the configuration of other models or functionalities at the transmitting node following the expected activation/deactivation of the specified models.
   For example, if the transmitting node has requested the receiving node to activate a model that performs an enhanced CSI compression, the transmitting node may communicate a change in the configuration of the resources utilized for CSI reporting.

### Model Activation Deactivation Notification

According to certain embodiments, the model activation/deactivation notification may include at least one of the following information fields:
1) Model ID field: Comprising the model(s) ID deactivated/activated by the transmitting node.
   In some particular embodiments, the model ID can be inexplicitly indicated by a new UE capability that is linked to this model, or by a new report type that is associated to this model. The model ID could also be a reference just to functionality that would be implemented in part with a ML based model.
2) Functionality area ID field: Comprising the functionality area ID of the model(s) to activate/deactivate by the receiving node, which characterizes the purpose of the model ID, e.g., channel estimation, decoding, etc.
   In some particular embodiments, there can be multiple models associated to the same functionality area ID. In this case, if no specific model ID is indicated, the receiving node may activate/deactivate all models that are associated to the functionality area ID, or the receiving node may activate/deactivate all models that are associated to this functionality area ID except for a default/fallback model.
3) Activate deactivate field: Indicating whether the specified model(s) in the model ID field are to be activated or deactivated.
4) Condition field: Comprising a set of condition/s to activate/deactivate/swap the specified model(s).
   Additionally, the alternative model to be activated/deactivated when a specific condition or set of conditions are satisfied may be specified.
5) Purpose field: Determining whether the activation/deactivation request/suggestion is performed for a) communication-related, or b) performance evaluation/model retraining purposes.
   In a particular embodiment, the signaling may include additional information in the configuring the performance evaluation. This information may include the set of conditions to activate/deactivate models depending on the result of the performance evaluation.
6) Detailed model configuration field: Comprising detailed model configuration parameters, which may include one or more of, for example:
   The frequency bands/carriers/cells/TAGs (timing advance groups) where a model is to be activated/deactivated.
   The period of time during which a model is to be activated/deactivated.
   The indication of whether a response message is expected.
6) Detailed configuration field: Comprising information on one or more of:
   a. additional request/suggestion changes in the configuration of other models or functionalities at the receiving node as a result of the activation/deactivation of the specified models, and/or
   b. the changes in the configuration of other models or functionalities at the transmitting node as a result of the activation/deactivation of the specified models.

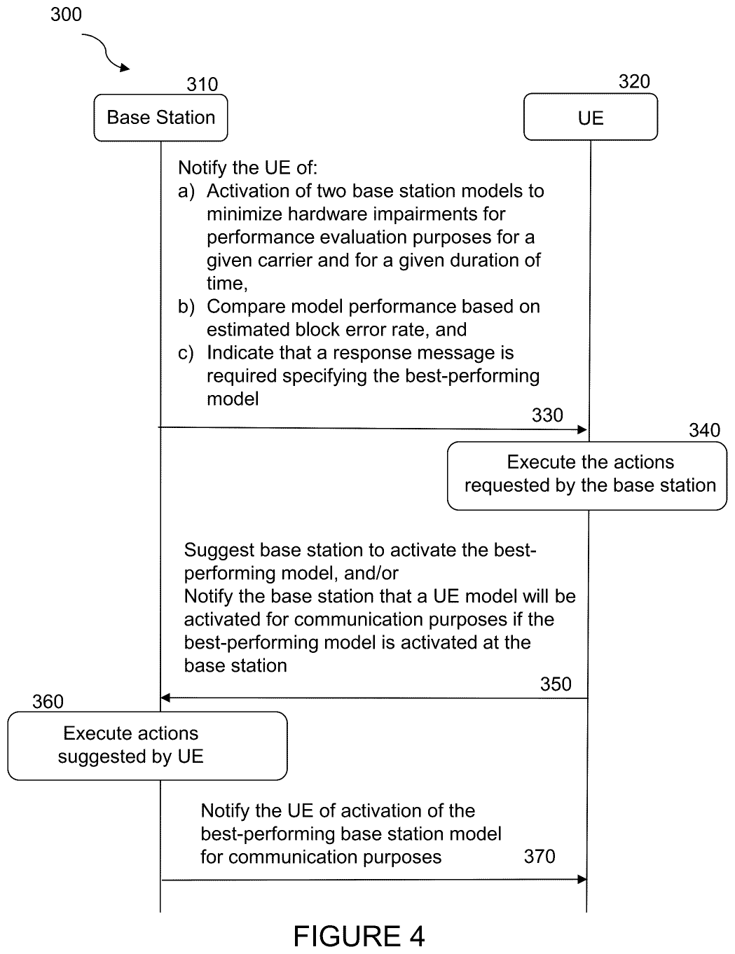

FIG. 4 illustrates another example 300 of signaling enabling a transmitter to suggest activation of two models for comparison, according to certain embodiments. Specifically, as illustrated in FIG. 4, the signaling enables a base station 310 of the signaling to request or suggest, at that a UE 320 to activate two AI/ML models for a given purpose. In a particular embodiment, for example, the base station 310 may request the activation of two AI/ML models for evaluation purposes and for minimizing hardware impairments. In a particular embodiment, the message transmitted at step 330 may notify the UE 320 of the method that the UE 320 should use to compare performance of the models/functionalities. In a particular embodiment, the message may additionally indicate that UE 320 should identify and report back information on the best-performing model.

At step 340, the UE 320 may execute the actions requested by the base station 310.

At step 350, the UE 320 may transmit a message to the base station 310 to suggest that the base station 310 activate the best performing model. Additionally or alternatively, the UE 320 may notify the base station 310 that a UE-based AI/ML model will be activated for communication purposes if the best-performing model is activated at the base station 310.

At step 360, the base station 310 may execute the actions suggested by the UE 320.

At step 370, the base station 310 may notify the UE 320 of the activation of the best-performing base station-based model for communication purposes.

In particular embodiments, the activation/deactivation notification may be a unicast message, a multicast message, or a broadcast message. In a further particular embodiment, the message may be signaled as an RRC message, MAC CE message, random-access message, or as an L1 message. The message may be sent from the network to the UE or the other way around.

In a further particular embodiment, the L1 message may, for example, be a Downlink Control Information (DCI) format or a sidelink control information (SCI) format message that is designed/transmitted in one or more of the following ways. In a particular embodiment, the method to identify that the message is a model activation/deactivation notification message may be indicated by an RNTI that is specific for that purpose, by letting other fields in a DCI/SCI format that can be used for other purposes to be set in a manner to identify the message being a model activation/deactivation notification, a specific size in number of bits, or a specific search space for PDCCH/PSCCH carrying this DCI/SCI. In another example, the L1 message can be a random-access preamble or an uplink control information (UCI) message that is specifically designed for indicating the activation/deactivation request/suggestion, or/and transmitted in specific radio resources associated to this purpose. If the message is a MAC CE, the message can be identified by a specific eLCID or by a specific field contained in this MAC CE.

Further it can be so that there are separate messages for each defined model and/or for each of the activation notification and deactivation notification.

The configuration message described above may configure the UE per cell, bandwidth part (BWP), TAG or/and cell group, and each configuration may have a different instance of the model and by that further separate activation/deactivation of the model.

In some particular embodiments, the model activation/deactivation notification may be an independent message. In other particular embodiments, the model activation/deactivation notification may be part of other messages.

### Condition Field

In some particular embodiments where the condition field is not empty, the transmitting node may utilize this field to inform the receiving node of the conditions that are evaluated to activate/deactivate/swap the specified model(s). These conditions may refer to one or more of, for example:
a) Changes in the active/inactive model(s) at the same or a different node.
   For example, the transmitting node may indicate the model(s) it intends to use depending on the model(s) selected by the receiving node.
b) Network-related conditions (e.g., cell/carrier activation/deactivation).
   For example, if the transmitting node is a base station, the condition field may indicate the model(s) utilized when serving a dual-connected UE.
   As another example, if the transmitting node is a base station, the condition field may indicate the model utilized depending on the selected BWP.
c) Type(s) of wireless traffic (i.e., QoS, access identity, access category, network slice) of the communication.
   For example, if the transmitting node is a base station, the condition field may indicate the model(s) utilized when transmitting downlink traffic with certain QoS Class Identifiers (QCIs), 5QIs (5G QOS Identifiers), access identities/categories, or network slices.
d) Time and date.
   For example, if the transmitting node is a base station, the condition field may indicate the model(s) utilized during the daytime, where the traffic load is typically high, and/or the model(s) utilized during the night when traffic load is typically low.
e) Signal-dependent conditions (e.g., serving/interfering RSRPs, SINRs above/below a given threshold, used reference signal pattern, e.g., number of symbols that contain DMRS in time and/or in frequency or a DMRS pattern type, or LoS/NLOS channel conditions).
   For example, if the transmitting node is a base station, the condition field may indicate the model the base station utilizes to serve UEs reporting RSRP values below a given value.
   As another example, if the base station transmits PDSCH with a specific DMRS pattern, the base station will use certain ML-model within its transmitter chain and, if the bae station transmits with another DMRS pattern, the base station will use another ML-model. The DMRS pattern may, for example, be given by the number symbol of DMRSs within the PDSCH, where the first DMRS symbol within the PDSCH is located, e.g., if it is located in the first symbol or not or the frequency density of the DMRS for PDSCH.
   As another example, if the transmitting node is a base station, the condition field may indicate the model(s) the UE utilizes depending on whether the UE is LoS or NLoS.
f) UE-dependent conditions (e.g., based on the battery level or the mobility of the device).
   For example, if the transmitting node is a UE, the condition field may indicate the serving base station that it will activate a specific model if the battery level is below a certain threshold. For instance, this may allow the UE to save energy while using an ML model instead of legacy procedure by, e.g., predicting a measurement instead of measuring.
   As another example, if the transmitting node is a UE, the condition field may indicate to the serving base station that it will not perform a subsequent model activation/deactivation because it may not be able to afford the extra energy spent on loading and/or using certain models.
   For instance, if the transmitting node is a UE observing that the wireless channel varies at a very low rate, the condition field may indicate to the base station that the UE has activated an ML model to learn its environment and adapt its radio operations to said environment. In another example, a highly mobile UE can activate a mobility predictor, in order to improve future, inter/intra-handover decisions.

In some particular embodiments where condition information fields are not empty, the transmitter may indicate the period of time where the set of conditions specified are applicable.

In some particular embodiments where the model activation/deactivation notification is part of other messages, the conditions may be implicitly related to the configuration being performed for such messages. For example, if the transmitting node is a base station transmitting a message to configure a given BWP, such message may include at least the model ID field specifying the models to be utilized by the base station when utilizing such BWP.

### Purpose Field

In some particular embodiments where the purpose field indicates that the model activation/deactivation is performed for performance evaluation purposes, the purpose field may indicate that the performance evaluation may be based on, for example, a comparison between i) the outputs obtained by a model when using known/training information against ii) the known expected outputs that should obtained by a well-functioning model.

In some particular embodiments where the purpose field activation/deactivation of the model/s ID indicates that the activation/deactivation is performed for performance evaluation purposes, the condition field may include information on the method/s that should be executed during a given performance evaluation.

### Detailed Model Configuration Field

The detailed model configuration field may include information on one or more of, for example:
The frequency bands/carriers where a model is to be activated/deactivated.
   For example, if the communication is simultaneously carried out via a low-frequency carrier (e.g., sub-6 GHz) and a high-frequency carrier (e.g., mmWave), the transmitter may send the model activation/deactivation in the low-frequency carrier and indicate that an ML-based model focused on dealing with hardware impairments may be activated only for the high-frequency carrier.
The period of time a model is to be activated/deactivated.
   For example, the transmitting node may activate the model(s) for a predetermined duration of time, e.g., when the model is activated for performance evaluation purposes.
   As another example, the transmitting node may activate a model from a given point in time and until further notice.
   As still another example, the transmitting node may specify the period time depending on the allowed alternatives defined in the specification text.
The indication of whether a response message is expected.
   In some particular embodiments, the node receiving the model activation/deactivation notification may not signal a response to the node that transmitted the model activation/deactivation notification.
      If the purpose field of the model activation/deactivation notification indicates that the model activation/deactivation is for communication-related purposes, such lack of response may be interpreted by the node transmitting the activation/deactivation notification as an implicit acceptance of the adopted model.
      If the purpose field of the model activation/deactivation notification indicates that the model activation/deactivation is for performance evaluation purposes, such lack of response may be interpreted based on previous configuration signaling or specification text, e.g., in the following manners:
         If a single model was activated for performance evaluation purposes, the lack of response may be interpreted as an indication to activate/deactivate such model for communication-related purposes.
         If multiple models were activated for performance evaluation purposes, the lack of response may be interpreted as an indication to activate/deactivate the default model for communication-related purposes.
   In some particular embodiments, the node receiving the model activation/deactivation notification may signal a response to the node that transmitted the model activation/deactivation notification. In some embodiments where a single model was activated for performance evaluation purposes, such response may only include a single bit indicating whether the model was deemed to perform satisfactorily or not. In other embodiments, such response may the form of the signaling described in the above section relating to According to certain embodiments, for example, methods and systems are provided to address the limitations discussed above so as to allow AI/ML model management in terms of, for example, supervision of model performance (understanding how well models perform in the network) and/or tailored performance to specific conditions (e.g., using different models depending on energy level in the executing node or received signal quality). Specifically, these objectives may be achieved by introducing communication between radio nodes in the network to allow the management of models implemented at the UE and/or the network. The communication outlined in certain embodiments described herein enables, e.g., performance monitoring of configured models.

FIG. 2 illustrates example signaling 100 for efficient AI/ML model management between two nodes in a wireless network, according to certain embodiments. Specifically, FIG. 2 demonstrates communication support between a first node 110 and a second node 120 that includes:
3) at step 130, requesting/suggesting the configuration (e.g., the activation/deactivation) of specific models for communication and/or performance evaluation purposes at the second node 120; and
4) at step 140, notifying the first node 110 of the configuration (e.g., activation/deactivation) of specific models for communication and/or performance evaluation and/or communicate and/or suggest modifications in the configurations as a result of the model activation/deactivation.

In a particular embodiment, the first node 110 includes a radio node that controls the ML model management and the second node 120 includes a radio node that will consider the request/suggestions on ML model configurations provided by the first node 110. In some embodiments, only one of the depicted signaling messages (request/suggest message or notification message) may be transmitted.

In a particular embodiment, the configuration may specify a set of condition(s) that should or will be evaluated to activate/deactivate the specified models for communication and/or performance evaluation purposes at the primary or secondary node. In addition, such configuration may also specify:
c) the set of conditions to activate/deactivate models for communication-related purposes depending on the result of the performance evaluation, and/or
d) a modified configuration that may be implemented as a result of the model activation/deactivation.
   Model Activation Deactivation Request Suggestion Signaling.

### Detailed Configuration Field

The detailed configuration field may include information on, for example:
additional request/suggestion changes in the configuration of other models or functionalities at the receiving node as a result of the activation/deactivation of the specified models, and/or
   For example, if the transmitting node is a base station, the signaling may indicate the receiver to change its uplink power control configuration as a result of activating/deactivating a model related to data reception.
the changes in the configuration of other models or functionalities at the transmitting node as a result of the activation/deactivation of the specified models.
   For example, if the transmitting node is a base station, the signaling may indicate a change in the downlink DMRS configuration when a model utilized for downlink communication-related purposes is activated/deactivated.

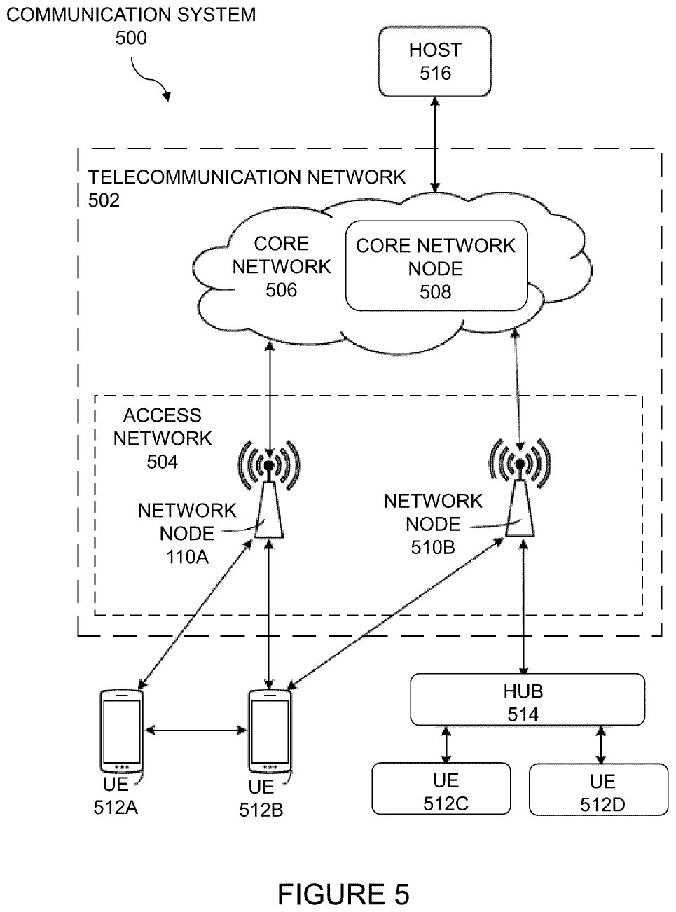

FIG. 5 shows an example of a communication system 500 in accordance with some embodiments. In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3rd Generation Partnership Project (3GPP) access node or non-3GPP access point. The network nodes 510 facilitate direct or indirect connection of user equipment (UE), such as by connecting UEs 512a, 512b, 512c. and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G. 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub-that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

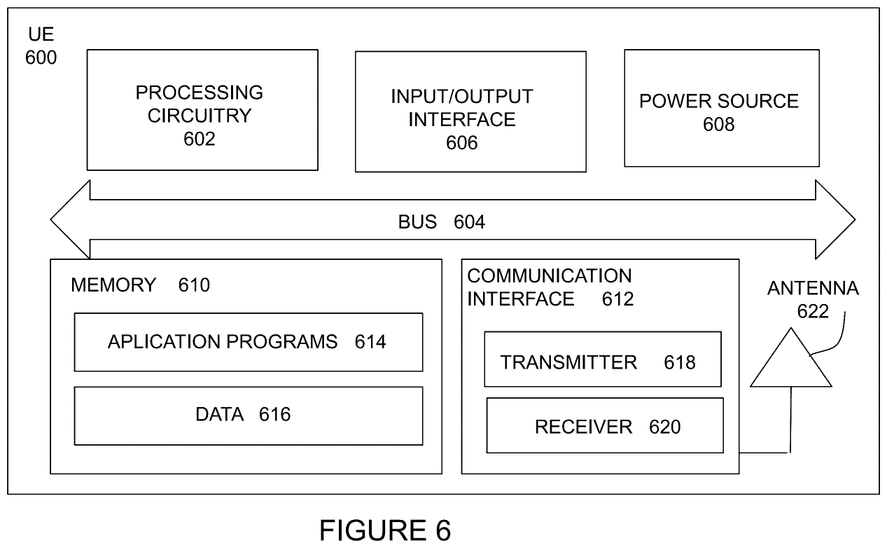

FIG. 6 shows a UE 600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612. and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function. or any combination thereof. Communications may be implemented in according to one or more communication protocols and/or standards, such as IEEE 802.11. Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

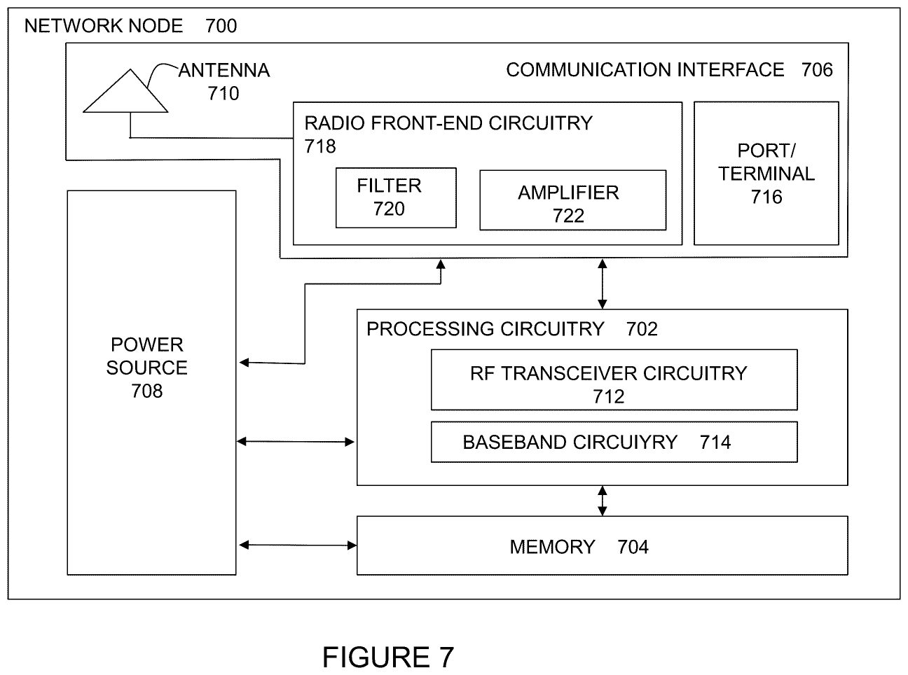

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710) may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710) and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

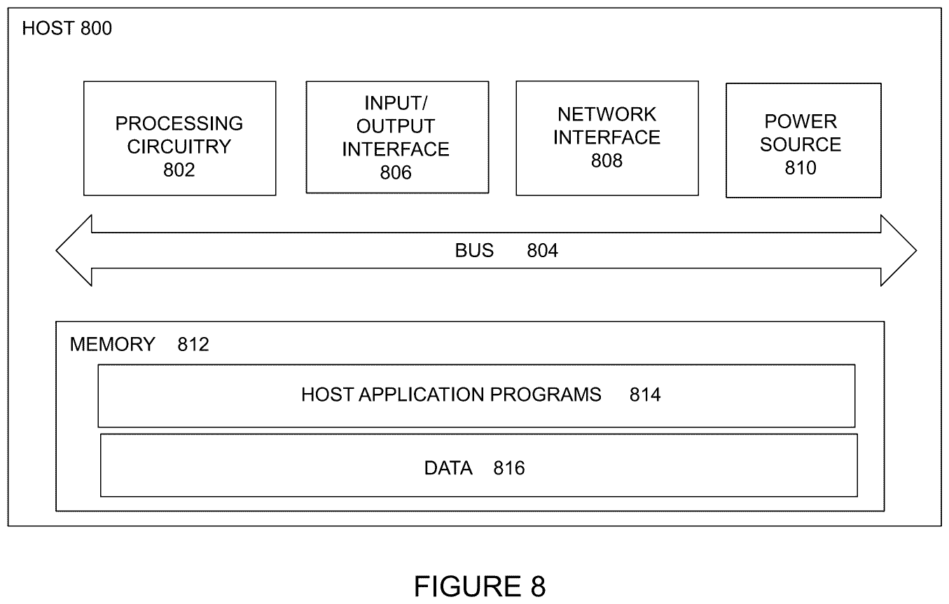

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs. The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

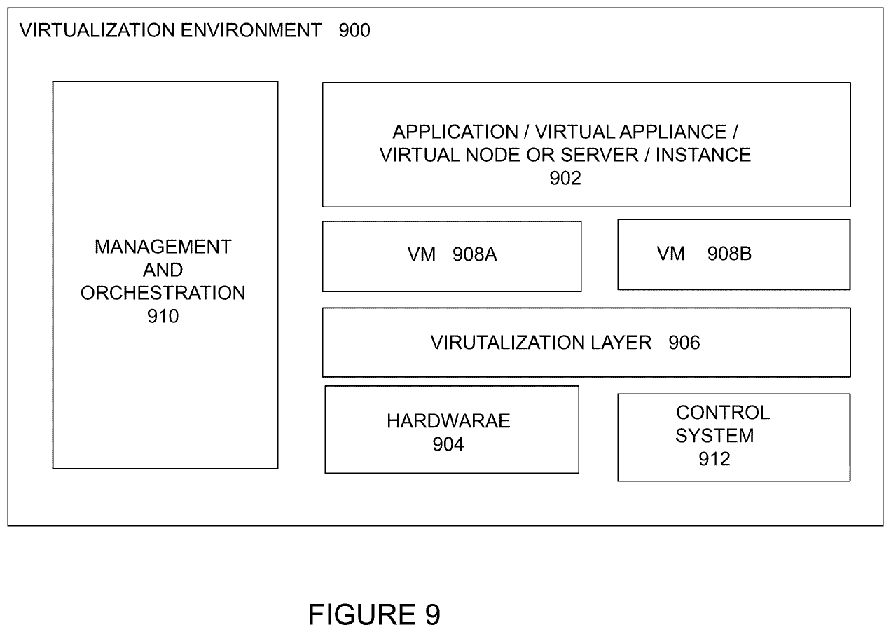

FIG. 9 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances. network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

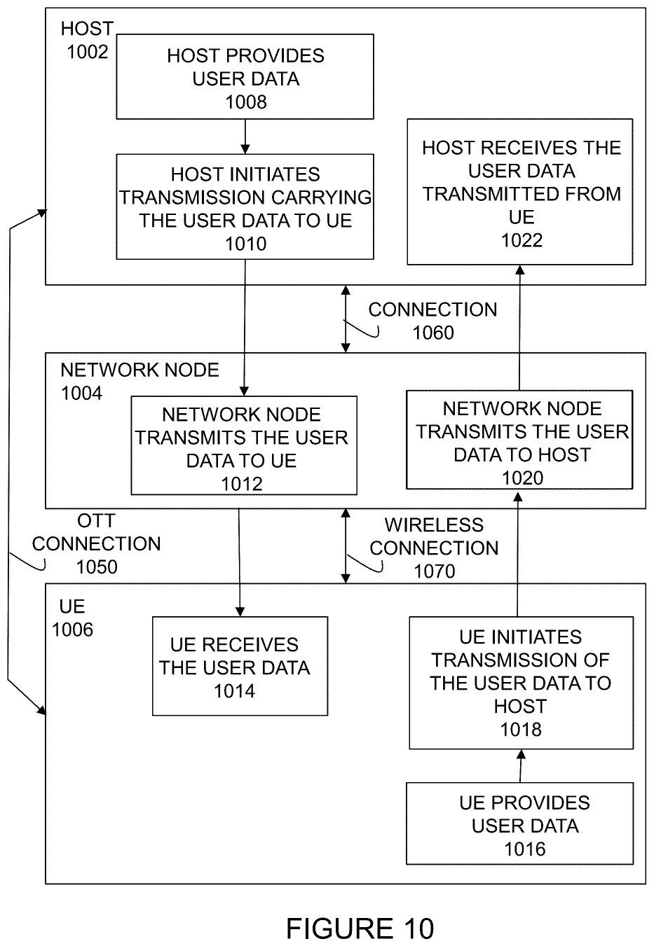

FIG. 10 shows a communication diagram of a host 1002 communicating via a network node 1004 with a UE 1006 over a partially wireless connection in accordance with some embodiments.

Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet. The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

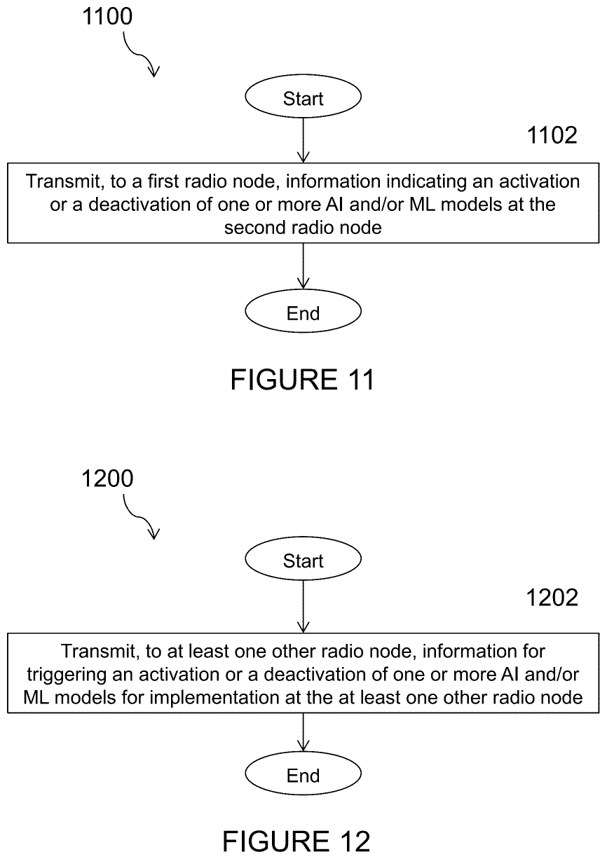

FIG. 11 illustrates a method 1100 by a second radio node 120, 220, 320, according to certain embodiments. The method includes transmitting, at step 1102, to a first radio node 110, 210, 310, information indicating an activation or a deactivation of one or more AI and/or ML models at the first radio node 110, 210, 310.

In a particular embodiment, prior to transmitting the information indicating the activation or deactivation of the one or more AI and/or ML models the method includes receiving, from the first radio node 110, 210, 310, information triggering the activation or the deactivation of the one or more AI and/or ML models at the second radio node 120, 220, 320.

In a further particular embodiment, the information triggering the activation or the deactivation of the one or more AI and/or ML models comprises at least one of: model identification information; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected; information indicating at least one change to the one or more AI and/or ML models at the second radio node 120, 220, 320; and information indicating at least one change to at least one AI and/or ML model at the first radio node 110, 210, 310.

In a particular embodiment, the second radio node 120, 220, 320 receives, from the first radio node 110, 210, 310, information indicating a configuration of the one or more AI and/or ML models for implementation at the second radio node 120, 220, 320.

In a particular embodiment, the second radio node 120, 220, 320 transmits, to the first radio node 110, 210, 310, information indicating a configuration of the one or more AI and/or ML models for implementation at the second radio node 120, 220, 320.

In a particular embodiment, the configuration comprises at least one condition associated with the activation and/or the deactivation of the one or more AI and/or ML models.

In a particular embodiment, the configuration comprises a modified configuration of the one or more AI and/or ML models.

In a particular embodiment, the second radio node 120, 220, 320 receives, from the first radio node 110, 210, 310, at least one modification to the configuration transmitted to the first radio node 110, 210, 310.

In a particular embodiment, the second radio node 120, 220, 320 receives, from the first radio node 110, 210, 310, the one or more AI and/or ML models for implementation at the second radio node 120, 220, 320.

In a particular embodiment, the second radio node 120, 220, 320 transmits, to the first radio node 110, 210, 310, at least one of: model identification information indicating the one or more AI and/or ML models for implementation at the second radio node 120, 220, 320; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected; and information indicating at least one change to at least one other AI and/or ML model.

In a particular embodiment, the second radio node 120, 220, 320 activates at least two AI and/or ML models during a duration of time, compares model performance of the at least two AI and/or ML models, and selects one of the at least two AI and/or ML models.

In a further particular embodiment, the second radio node 120, 220, 320 receives, from the first radio node 110, 210, 310, information indicating the at least two AI and/or ML models for activation.

In a further particular embodiment, when comparing the model performance, the second radio node 120, 220, 320 compares a block error rate of the at least two AI and/or ML models. The second radio node 120, 220, 320 selects the one of the at least two AI and/or ML models that has a best block error rate.

In a further particular embodiment, the information indicating the activation or the deactivation of the one or more AI and/or ML models at the second radio node 120, 220, 320 comprises information indicating the activation of the selected one of the at least two AI and/or ML models.

In a particular embodiment, the second radio node 120, 220, 320 transmits, to at least one other radio node, information triggering the activation or the deactivation of the one or more AI and/or ML models at the at least one other radio node.

In a particular embodiment, the information indicating the activation or the deactivation of the one or more AI and/or ML models at the second radio node 120, 220, 320 is transmitted as a unicast message, a multicast message, or a broadcast message.

In a particular embodiment, the information indicating the activation or the deactivation of the one or more AI and/or ML models at the second radio node is transmitted as a Radio Resource Control message, a Medium Access Control-Control Element message, a Random Access message, or a Layer 1 message.

In a particular embodiment, the second radio node 120, 220, 320 is a base station or a UE.

In a particular embodiment, the first radio node 110, 210, 310 is a base station or a UE.

FIG. 12 illustrates a method 1200 by a first radio node 110, 210, 310, according to certain embodiments. The method includes transmitting, at step 1202, to at least one other radio node, information for triggering an activation or a deactivation of one or more AI and/or ML models for implementation at the at least one other radio node.

In a particular embodiment, the at least one other radio node includes a second radio node 120, 220, 320.

In a particular embodiment, the first radio node 110, 210, 310 receives, from the at least one other radio node, information indicating the activation or the deactivation of the one or more AI and/or ML models at the at least one other radio node.

In a particular embodiment, the first radio node 110, 210, 310 transmits, to the at least one other radio node, a configuration of the one or more AI and/or ML models for implementation at the at least one other radio node.

In a particular embodiment, the first radio node 110, 210, 310 receives, from the at least one other radio node, a configuration of the one or more AI and/or ML models for implementation at the at least one other radio node.

In a particular embodiment, the configuration comprises at least one condition associated with the activation and/or deactivation of the one or more AI and/or ML models at the at least one other radio node.

In a particular embodiment, the configuration comprises a modified configuration of the one or more AI and/or ML models at the at least one other radio node.

In a particular embodiment, the first radio node 110, 210, 310 transmits, to the at least one other radio node, at least one modification to the configuration received from the at least one other radio node.

In a particular embodiment, the first radio node 110, 210, 310 transmits, to the at least one other radio node, the one or more AI and/or ML models for implementation at the at least one other radio node.

In a particular embodiment, the information for triggering the activation or the deactivation of the one or more AI and/or ML models for implementation at the at least one other radio node comprises at least one of: model identification information; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected; information indicating at least one change to the one or more AI and/or ML models at the at least one other radio node; and information indicating at least one change to at least one AI and/or ML model at the first radio node 110, 210, 310.

In a particular embodiment, the first radio node 110, 210, 310 activates at least two AI and/or ML models during a duration of time, compares model performance of the at least two AI and/or ML models; and selects one of the two AI and/or models for activation at the at least one other radio node. The information transmitted to the at least one other radio node for triggering the activation or the deactivation of one or more AI and/or ML models indicates the selected one of the two AI and/or ML models for activation at the at least one other radio node.

In a particular embodiment, the information transmitted to the at least one other radio node for triggering the activation or the deactivation of one or more AI and/or ML models indicates at least two AI and/or ML models to be activated during a duration of time for comparison of model performance.

In a further particular embodiment, the first radio node 110, 210, 310 receives, from the at least one other radio node, a response message comprising at least one of: information indicating that the at least two AI and/or ML models have been activated, information indicating a configuration change to at least one of the at least two AI and/or ML models, and information associated with a comparison of the model performance of the at least two AI and/or ML models.

In a further particular embodiment, when comparing the model performance, the first radio node 110, 210, 310 compares a block error rate of the at least two AI and/or ML models, and the one of the at least two AI and/or ML models that has a best block error rate is selected.

In a particular embodiment, the information for triggering the activation or the deactivation of one or more AI and/or ML models at the at least one other model is transmitted as a unicast message, a multicast message, or a broadcast message.

In a particular embodiment, the information for triggering the activation or the deactivation of one or more AI and/or ML models at the at least one other model transmitted as a Radio Resource Control message, a Medium Access Control-Control Element message, a Random Access message, or a Layer1 message.

In a particular embodiment, the first radio node 110, 210, 310 is a base station or a UE.

In a particular embodiment, the at least one other radio node includes a UE or a base station.

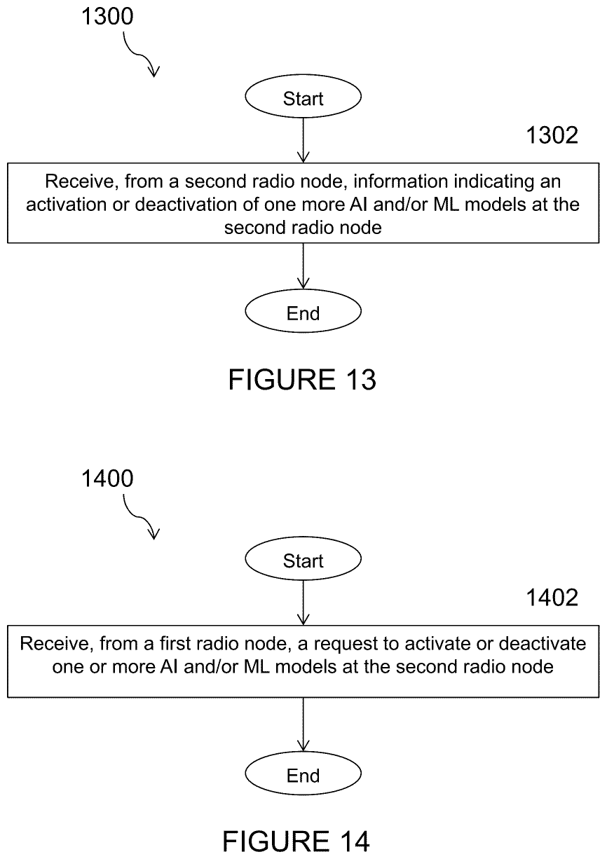

FIG. 13 illustrates a method 1300 by a first radio node 110, 210, 310, according to certain embodiments. The method includes receiving, at step 1302, from a second radio node 110, 210, 310, information indicating an activation or a deactivation of one or more AI and/or ML models at the second radio node. In various particular embodiments, the method may further include any of the steps or features recited in any of the Example Embodiments disclosed below.

FIG. 14 illustrates a method 1400 by a second radio node, according to certain embodiments. The method includes receiving, at step 1402, from a first radio node 110, 210, 310, a request to activate or a deactivate of one or more AI and/or ML models at the second radio node. In various particular embodiments, the method may further include any of the steps or features recited in any of the Example Embodiments disclosed below.

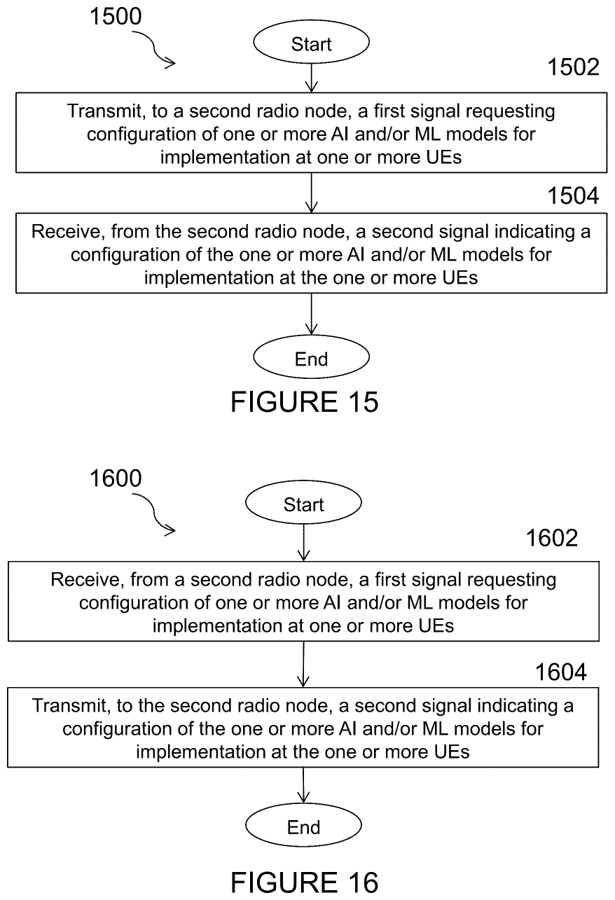

FIG. 15 illustrates a method 1500 by a first radio node 110, 210, 310, according to certain embodiments. The method includes transmitting, at step 1502, to a second radio node 120, 220, 320, a first signal requesting configuration of one or more AI and/or ML models for implementation at one or more UEs. At step 1504, the second radio node transmits a second signal indicating a configuration of the one or more AI and/or ML models for implementation at the one or more UEs.

In a particular embodiment, the second radio node is one of the one or more UEs.

In various particular embodiments, the method may further include any of the steps or features recited in the Group C Example Embodiments disclosed below.

FIG. 16 illustrates a method 1600 by a first radio node 110, 210, 310, according to certain embodiments. The method includes receiving, at step 1602, from a second radio node 120, 220, 320, a first signal requesting configuration of one or more AI and/or ML models for implementation at one or more UEs. At step 1604, the first radio node 110, 210, 310 transmits, to the second radio node 120, 220, 320, a second signal indicating a configuration of the one or more AI and/or ML models for implementation at the one or more UEs.

In a particular embodiment, the first radio node is one of the one or more UEs.

In various particular embodiments, the method may further include any of the steps or features recited in the Group D Example Embodiments disclosed below.

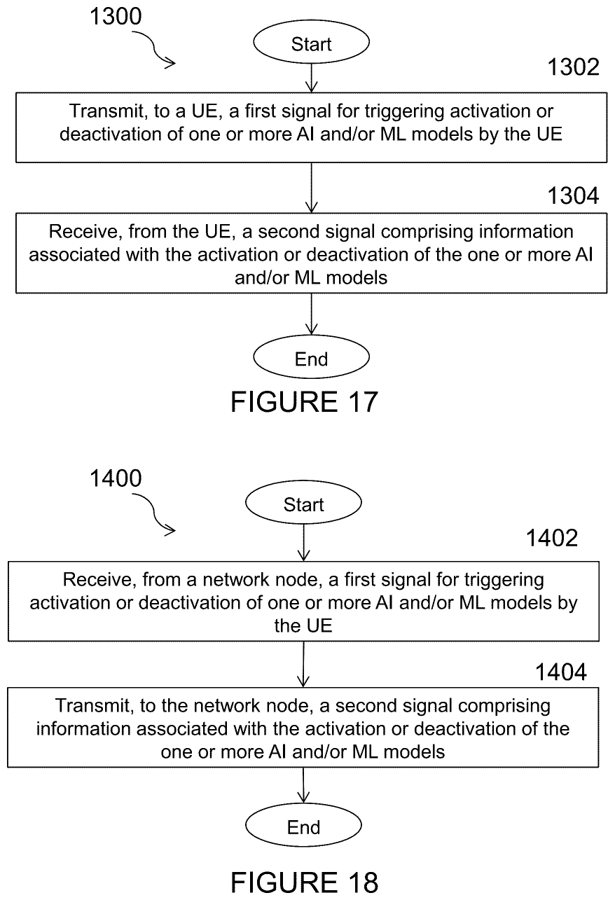

FIG. 17 illustrates a method 1700 by a network node 110, according to certain embodiments. The method includes transmitting, at step 1702, to a UE 112, a first signal for triggering activation or deactivation of one or more AI and/or ML models by the UE 112. At step 1704, the network node 110 receives, from the UE 112, a second signal comprising information associated with the activation or deactivation of the one or more AI and/or ML models for implementation at the one or more UEs.

In various particular embodiments, the method may further include any of the steps or features recited in the Group E Example Embodiments disclosed below.

FIG. 18 illustrates a method 1800 by a UE 112, according to certain embodiments. The method includes receiving, at step 1802, from a network node 110, a first signal for triggering activation or deactivation of one or more AI and/or ML models by the UE. At step 1804, the UE 112 transmits, to the network node 110, a second signal comprising information associated with the activation or deactivation of the one or more AI and/or ML models for implementation at the one or more UEs.

In various particular embodiments, the method may further include any of the steps or features recited in the Group F Example Embodiments disclosed below.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method by a user equipment comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a first radio node comprising: transmitting, to a second radio node, a first signal requesting configuration of one or more Artificial Intelligence (AI) and/or Machine Learning (ML) models for implementation at one or more user equipments (UEs); and receiving, from the second radio node, a second signal indicating a configuration of the one or more AI and/or ML models for implementation at the one or more UEs.

Example Embodiment C2. The method of Example Embodiment C1, wherein the configuration comprises at least one condition associated with an activation and/or deactivation of the one or more AI and/or ML models.

Example Embodiment C3. The method of any one of Example Embodiments C1 to C2, wherein the configuration comprises a modified configuration of the one or more AI and/or ML models.

Example Embodiment C4. The method of any one of Example Embodiments C1 to C3, further comprising implementing the one or more AI and/or ML models.

Example Embodiment C5. The method of any one of Example Embodiments C1 to C4, further comprising transmitting, the one or more UEs, the one or more AI and/or ML models for implementation by the one or more UEs.

Example Embodiment C6. The method of any one of Example Embodiments C3 to C5, further comprising transmitting, to the second radio node, a third signal indicating at least one modification to the configuration.

Example Embodiment C7. The method of any one of Example Embodiments C1 to C6, wherein the first signal comprises at least one of: model identification information; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected: and information indicating at least one change to at least one other AI and/or ML model.

Example Embodiment C8. The method of any one of Example Embodiments C1 to C7, further comprising: activating at least two AI and/or ML models during a duration of time; and comparing model performance of the at least two AI and/or ML models.

Example Emboidment C9. The method of Example Embodiment C8, wherein the first signal indicates a selected one of the two AI and/or ML models for activation.

Example Embodiment C10. The method of any one of Example Embodiments C8 to C9, further comprising transmitting to the one or more UEs information indicating the selected one of the two AI and/or ML models for activation.

Example Embodiment C11. The method of Example Embodiment C10, receiving, from the one or more UEs, a response message indicating at least one of: information indicating that the selected one of the two or more AI and/or ML models has been activated, information indicating a configuration change to the selected one of the two or more AI and/or ML models.

Example Embodiment C12. The method of any one of Example Embodiments C8 to C11, wherein comparing the model performance comprises comparing a block error rate of the at least two AI and/or ML models, and further comprising selecting the one of the two AI and/or ML models that has a best block error rate.

Example Embodiment C13. The method of any one of Example Embodiments C8 to C12, wherein the second signal indicates an activation of the selected one of the two AI and/or ML models.

Example embodiment C14. The method of any one of Example Embodiments C1 to C13, wherein the first radio node is a first base station and the second radio node is a second base station.

Example Embodiment C15. The method of any one of Example Embodiments C1 to C13, wherein the first radio node is a base station and the second radio node is a first UE.

Example Embodiment C16. The method of Example Embodiment C15, wherein the first UE is one of the one or more UEs.

Example Embodiment C17. The method of any one of Example Embodiments C1 to C16, wherein the first signal is a unicast message, a multicast message, or a broadcast message.

Example Embodiment C18. The method of any one of Example Embodiments C1 to C17, wherein the first signal is a RRC message, a MAC CE message, a RA message, or an L1 message.

Example Embodiment C19. The method of any of the previous Example Embodiments, further comprising: providing user data; and forwarding the user data to a host computer via the transmission to the network node.

Example Embodiment C20. The method of any of the previous Example Embodiments, further comprising: obtaining user data; and forwarding the user data to a host or a user equipment.

Example Embodiment C21. A user equipment comprising processing circuitry configured to perform any of the methods of Example Embodiments C1 to C20.

Example Embodiment C22. A wireless device comprising processing circuitry configured to perform any of the methods of Example Embodiments C1 to C20.

Example Embodiment C23. A computer program comprising instructions which when executed on a computer perform any of the methods of Example Embodiments C1 to C20.

Example Embodiment C24. A computer program product comprising computer program, the computer program comprising instructions which when executed on a computer perform any of the methods of Example Embodiments C1 to C20.

Example Embodiment C25.A non-transitory computer readable medium storing instructions which when executed by a computer perform any of the methods of Example Embodiments C1 to C20.

### Group D Example Embodiments

Example Embodiment D1. A method by a first radio node comprising: receiving, from a second radio node, a first signal requesting configuration of one or more Artificial Intelligence (AI) and/or Machine Learning (ML) models for implementation at one or more user equipments (UEs); and transmitting, to the second radio node, a second signal indicating a configuration of the one or more AI and/or ML models for implementation at the one or more UEs.

Example Embodiment D2. The method of Example Embodiment D1, wherein the configuration comprises at least one condition associated with an activation and/or deactivation of the one or more AI and/or ML models.

Example Embodiment D3. The method of any one of Example Embodiments D1 to D2, wherein the configuration comprises a modified configuration of the one or more AI and/or ML models.

Example Embodiment D4. The method of any one of Example Embodiments D1 to D3, further comprising receiving, from the second radio node, a third signal indicating at least one modification to the configuration.

Example Embodiment D5. The method of any one of Example Embodiments D1 to D4, wherein the first signal comprises at least one of: model identification information; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected; and information indicating at least one change to at least one other AI and/or ML model.

Example Embodiment D6. The method of any one of Example Embodiments D1 to D5, further comprising: activating at least two AI and/or ML models during a duration of time; and comparing model performance of the at least two AI and/or ML models.

Example Emboidment D7. The method of Example Embodiment D6, wherein the first signal indicates a selected one of the two AI and/or ML models for activation.

Example Embodiment D8. The method of any one of Example Embodiments D6 to D7, wherein comparing the model performance comprises comparing a block error rate of the at least two AI and/or ML models, and further comprising selecting the one of the two AI and/or ML models that has a best block error rate.

Example Embodiment D9. The method of any one of Example Embodiments D1 to D8, wherein the second signal indicates an activation of the selected one of the two AI and/or ML models.

Example embodiment D10. The method of any one of Example Embodiments D1 to D9, wherein the first radio node is a first base station and the second radio node is a second base station.

Example Embodiment D11. The method of any one of Example Embodiments D1 to D9, wherein the first radio node is a first UE and the second radio node is a base station.

Example Embodiment D12. The method of Example Embodiment C11, wherein the first UE is one of the one or more UEs.

Example Embodiment D13. The method of any one of Example Embodiments D1 to D12, wherein the first signal is a unicast message, a multicast message, or a broadcast message.

Example Embodiment D14. The method of any one of Example Embodiments D1 to D17, wherein the first signal is a RRC message, a MAC CE message, a RA message, or an L1 message.

Example Embodiment D15. The method of any of the previous Example Embodiments, further comprising: providing user data; and forwarding the user data to a host computer via the transmission to the network node.

Example Embodiment D16. The method of any of the previous Example Embodiments, further comprising: obtaining user data; and forwarding the user data to a host or a user equipment.

Example Embodiment D17. A user equipment comprising processing circuitry configured to perform any of the methods of Example Embodiments D1 to D16.

Example Embodiment D18. A wireless device comprising processing circuitry configured to perform any of the methods of Example Embodiments D1 to D16.

Example Embodiment D19. A computer program comprising instructions which when executed on a computer perform any of the methods of Example Embodiments D1 to D16.

Example Embodiment D20. A computer program product comprising computer program, the computer program comprising instructions which when executed on a computer perform any of the methods of Example Embodiments D1 to D16.

Example Embodiment D21. A non-transitory computer readable medium storing instructions which when executed by a computer perform any of the methods of Example Embodiments D1 to D16.

### Group E Example Embodiments

Example Embodiment E1. A method by a network node comprising: transmitting, to a user equipment (UE), a first signal for triggering activation or deactivation of one or more Artificial Intelligence (AI) and/or Machine Learning (ML) models by the UE; and receiving, from the UE, a second signal comprising information associated with the activation or deactivation of the one or more AI and/or ML models for implementation at the one or more UEs.

Example Embodiment E2. The method of Example Embodiment E1, wherein the first signal indicates at least one of: a configuration for the one or more AI and/or ML models; an indication to trigger the UE to compare a performance of two or more AI and/or ML models; an indication that a best one of the two or more AI and/or ML models is to be activated; at least one condition associated with the one or more AI and/or ML models; and a request for a response message.

Example Embodiment E3. The method of any one of Example Embodiments E1 to E2, wherein the information of the second signal comprises at least one of: an indication of an activation or deactivation of the one or more AI and/or ML models; a suggestion or request to activate a best performing one of the one or more AI and/or ML models; an indication that a first AI and/or ML model will be activated for communication purposes if a second AI and/or ML model is activated by the network node; and a request for a modification of at least one configuration or parameter associated with the one or more AI and/or ML models.

Example Embodiment E4. The method of any one of Example Embodiments E1 to E3, further comprising transmitting, the one or more UEs, the one or more AI and/or ML models for implementation by the one or more UEs.

Example Embodiment E5. The method of any one of Example Embodiments E1 to D4, further comprising transmitting, to another network node, a third signal indicating at least one modification to a configuration or parameter associated with the one or more AI and/or ML models.

Example Embodiment E6. The method of any one of Example Embodiments E1 to E5, wherein at least one of the first signal and the second signal comprises at least one of: model identification information; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected; and information indicating at least one change to at least one other AI and/or ML model.

Example Embodiment E7. The method of any one of Example Embodiments E1 to E6, wherein the second signal indicates an activation of a selected one of a plurality of AI and/or ML models.

Example Embodiment E8. The method of any one of Example Embodiments E1 to E7, wherein the first signal is a unicast message, a multicast message, or a broadcast message.

Example Embodiment E9. The method of any one of Example Embodiments E1 to E7, wherein the first signal is a RRC message, a MAC CE message, a RA message, or an L1 message.

Example Embodiment E10. The method of any one of Example Embodiments E1 to E9, further comprising performing at least one action based on the second signal.

Example Embodiment E11. The method of Example Embodiment E10, wherein the at least one action is suggested by the UE in the second signal.

Example Embodiment E12. The method of any one of Example Embodiments E1 to E11, further comprising transmitting, to the UE, a third signal indicating an activation of at least one AI and/or ML model by the network node.

Example Embodiment E13. The method of any of the previous Example Embodiments, further comprising: obtaining user data; and forwarding the user data to a host or a user equipment.

Example Embodiment E14. A user equipment comprising processing circuitry configured to perform any of the methods of Example Embodiments E1 to E13.

Example Embodiment E15. A wireless device comprising processing circuitry configured to perform any of the methods of Example Embodiments E1 to E13.

Example Embodiment E16. A computer program comprising instructions which when executed on a computer perform any of the methods of Example Embodiments E1 to E13.

Example Embodiment E17. A computer program product comprising computer program, the computer program comprising instructions which when executed on a computer perform any of the methods of Example Embodiments E1 to E13.

Example Embodiment E18. A non-transitory computer readable medium storing instructions which when executed by a computer perform any of the methods of Example Embodiments E1 to E13.

### Group F Example Embodiments

Example Embodiment F1. A method by a user equipment (UE) comprising: receiving, from a network node, a first signal for triggering activation or deactivation of one or more Artificial Intelligence (AI) and/or Machine Learning (ML) models by the UE; and transmitting, to the network node, a second signal comprising information associated with the activation or deactivation of the one or more AI and/or ML models for implementation at the one or more UEs.

Example Embodiment F2. The method of Example Embodiment F1, wherein the first signal indicates at least one of: a configuration for the one or more AI and/or ML models; an indication to trigger the UE to compare a performance of two or more AI and/or ML models; an indication that a best one of the two or more AI and/or ML models is to be activated; at least one condition associated with the one or more AI and/or ML models; and a request for a response message.

Example Embodiment F3. The method of any one of Example Embodiments F1 to F2, wherein the information of the second signal comprises at least one of: an indication of an activation or deactivation of the one or more AI and/or ML models; a suggestion or request to activate a best performing one of the one or more AI and/or ML models; an indication that a first AI and/or ML model will be activated for communication purposes if a second AI and/or ML model is activated by the network node; and a request for a modification of at least one configuration or parameter associated with the one or more AI and/or ML models.

Example Embodiment F4. The method of any one of Example Embodiments F1 to F3, further comprising receiving, from the network node, the one or more AI and/or ML models for implementation.

Example Embodiment F5. The method of any one of Example Embodiments F1 to F4, wherein at least one of the first signal and the second signal comprises at least one of: model identification information; model functionality information; activation information; deactivation information; at least one condition for the activation/deactivation of the one or more AI and/or ML models; model purpose information indicating whether the one or more AI and/or ML models are implemented for communication-related or performance evaluation/model retraining purposes; at least one model configuration parameter related to at least one of: frequency band, carrier, cell identifier, timing advance group parameter; a period of time during which the one or more AI and/or ML models are to activated or deactivated; an indication of whether a response message is expected; and information indicating at least one change to at least one other AI and/or ML model.

Example Embodiment F6. The method of any one of Example Embodiments F1 to F5, wherein the second signal indicates an activation of a selected one of a plurality of AI and/or ML models.

Example Embodiment F7. The method of any one of Example Embodiments F1 to F6, wherein the first signal is a unicast message, a multicast message, or a broadcast message.

Example Embodiment F8. The method of any one of Example Embodiments F1 to F6, wherein the first signal is a RRC message, a MAC CE message, a RA message, or an L1 message.

Example Embodiment F9. The method of any one of Example Embodiments F1 to F8, further comprising performing at least one action based on the first signal.

Example Embodiment F10. The method of Example Embodiment F9, wherein the at least one action is suggested by the network node in the first signal.

Example Embodiment F11. The method of any one of Example Embodiments F1 to F10, further comprising receiving, from the network node, a third signal indicating an activation of at least one AI and/or ML model by the network node.

Example Embodiment F12. The method of any one of Example Embodiments F1 to F11, further comprising: activating at least two AI and/or ML models during a duration of time; and comparing model performance of the at least two AI and/or ML models.

Example Emboidment F13. The method of Example Embodiment F12, wherein the first signal or the second signal indicates a selected one of the two AI and/or ML models for activation.

Example Embodiment F14. The method of any one of Example Embodiments F12 to F13, further comprising transmitting to the network node information indicating the selected one of the two AI and/or ML models.

Example Embodiment F15. The method of Example Embodiment F14, further comprising transmitting, to the network node, a response message indicating at least one of: information indicating that the selected one of the two or more AI and/or ML models has been activated, information indicating a configuration change to the selected one of the two or more AI and/or ML models.

Example Embodiment F16. The method of any one of Example Embodiments F12 to F15, wherein comparing the model performance comprises comparing a block error rate of the at least two AI and/or ML models, and further comprising selecting the one of the two AI and/or ML models that has a best block error rate.

Example Embodiment F17. The method of any one of Example Embodiments F12 to F16, wherein the second signal indicates an activation of the selected one of the two AI and/or ML models.

Example Embodiment F18. The method of any of the previous Example Embodiments, further comprising: obtaining user data; and forwarding the user data to a host or a user equipment.

Example Embodiment F19. A user equipment comprising processing circuitry configured to perform any of the methods of Example Embodiments F1 to F18.

Example Embodiment F20. A wireless device comprising processing circuitry configured to perform any of the methods of Example Embodiments F1 to F18.

Example Embodiment F21. A computer program comprising instructions which when executed on a computer perform any of the methods of Example Embodiments F1 to F18.

Example Embodiment F22. A computer program product comprising computer program, the computer program comprising instructions which when executed on a computer perform any of the methods of Example Embodiments F1 to F18.

Example Embodiment F23. A non-transitory computer readable medium storing instructions which when executed by a computer perform any of the methods of Example Embodiments F1 to F18.

### Group G Example Embodiments

Example Embodiment G1. A user equipment comprising: processing circuitry configured to perform any of the steps of any of the Group A, C, D, and F Example Embodiments; and power supply circuitry configured to supply power to the processing circuitry.

Example Embodiment G2. A network node comprising: processing circuitry configured to perform any of the steps of any of the Group B, C, D, and E Example Embodiments; power supply circuitry configured to supply power to the processing circuitry.

Example Embodiment G3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, C, D, and F Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment G4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, D, and F Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment G8. The method of the previous Example Embodiment, further comprising: at the host, executing a host application associated with a client application executing on the UE to receive the user data from the UE.

Example Embodiment G9. The method of the previous Example Embodiment, further comprising: at the host, transmitting input data to the client application executing on the UE, the input data being provided by executing the host application, wherein the user data is provided by the client application in response to the input data from the host application.

Example Emboidment G10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A, C, D, and F Example Embodiments to transmit the user data to the host.

Example Emboidment G11. The host of the previous Example Embodiment, wherein the cellular network further includes a network node configured to communicate with the UE to transmit the user data from the UE to the host.

Example Embodiment G12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G13. A method implemented by a host configured to operate in a communication system that further includes a network node and a user equipment (UE), the method comprising: at the host, receiving user data transmitted to the host via the network node by the UE, wherein the UE performs any of the steps of any of the Group A, C, D, and F Example Embodiments to transmit the user data to the host.

Example Embodiment G14. The method of the previous Example Embodiment, further comprising: at the host, executing a host application associated with a client application executing on the UE to receive the user data from the UE.

Example Embodiment G15. The method of the previous Example Embodiment, further comprising: at the host, transmitting input data to the client application executing on the UE, the input data being provided by executing the host application, wherein the user data is provided by the client application in response to the input data from the host application.

Example Embodiment G16. A host configured to operate in a communication system to provide an over-the-top (OTT) service, the host comprising: processing circuitry configured to provide user data: and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment G17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment G18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment G19. The method of the previous Example Embodiment, further comprising, at the network node, transmitting the user data provided by the host for the UE.

Example Embodiment G20. The method of any of the previous 2 Example Embodiments, wherein the user data is provided at the host by executing a host application that interacts with a client application executing on the UE, the client application being associated with the host application.

Example Embodiment G21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment G22. The communication system of the previous Example Embodiment, further comprising: the network node; and/or the user equipment.

Example Embodiment G23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment G24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G25. The host of the any of the previous 2 Example Embodiments, wherein the initiating receipt of the user data comprises requesting the user data.

Example Embodiment G26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, D, and E Example Embodiments to receive the user data from the UE for the host.

Example Embodiment G27. The method of the previous Example Embodiment, further comprising at the network node, transmitting the received user data to the host.

1.-43. (canceled)

44. A method by a first radio node comprising:
transmitting, to a second radio node, information indicating an activation or a deactivation of one or more Artificial Intelligence (AI) and/or Machine Learning (ML) models at the first radio node.

45. The method of claim 44, wherein prior to transmitting the information indicating the activation or deactivation of the one or more AI and/or ML models the method comprises:
receiving, from the second radio node, information triggering the activation or the deactivation of the one or more AI and/or ML models at the first radio node.

46. The method of claim 45, wherein the information triggering the activation or the deactivation of the one or more AI and/or ML models comprises at least one of:
model identification information;
model functionality information;
activation information;
deactivation information;
at least one condition for the activation/deactivation of the one or more AI and/or ML models;
model purpose information indicating whether the one or more AI and/or ML models are implemented for communication-related or performance evaluation/model retraining purposes;
at least one model configuration parameter related to at least one of: frequency band, carrier, cell identifier, timing advance group parameter;
a period of time during which the one or more AI and/or ML models are to activated or deactivated;
an indication of whether a response message is expected;
information indicating at least one change to the one or more AI and/or ML models at the first radio node; and
information indicating at least one change to at least one AI and/or ML model at the second radio node.

47. The method of claim 44, comprising receiving, from the second radio node, or transmitting, to the second radio node, information indicating a configuration of the one or more AI and/or ML models for implementation at the first radio node.

48. The method of claim 44, comprising:
activating at least two AI and/or ML models during a duration of time; and
comparing model performance of the at least two AI and/or ML models; and
selecting one of the at least two AI and/or ML models.

49. The method of 48, comprising receiving, from the second radio node, information indicating the at least two AI and/or ML models for activation.

50. The method of claim 48, wherein comparing the model performance comprises comparing a block error rate of the at least two AI and/or ML models, and wherein selecting the one of the at least two AI and/or ML models comprises selecting the one of the at least two AI and/or ML models that has a best block error rate.

51. The method of claim 44, wherein the first radio node is a base station or a UE, or wherein the second radio node is a base station or a UE.

52. A method by a second radio node comprising:
transmitting, to at least one other radio node, information for triggering an activation or a deactivation of one or more Artificial Intelligence, AI, and/or Machine Learning, ML, models for implementation at the at least one other radio node.

53. The method of claim 52, comprising receiving, from the at least one other radio node, information indicating the activation or the deactivation of the one or more AI and/or ML models at the at least one other radio node.

54. The method of claim 52, comprising transmitting, to the at least one other radio node, or receiving, from the at least one other radio node, a configuration of the one or more AI and/or ML models for implementation at the at least one other radio node.

55. The method of claim 54, wherein the configuration comprises at least one condition associated with the activation and/or deactivation of the one or more AI and/or ML models at the at least one other radio node.

56. The method of claim 55, wherein the configuration comprises a modified configuration of the one or more AI and/or ML models at the at least one other radio node.

57. The method of claim 52, comprising:
activating at least two AI and/or ML models during a duration of time;
comparing model performance of the at least two AI and/or ML models; and
selecting one of the two AI and/or models for activation at the at least one other radio node, and
wherein the information transmitted to the at least one other radio node for triggering the activation or the deactivation of one or more AI and/or ML models indicates the selected one of the two AI and/or ML models for activation at the at least one other radio node.

58. The method of claim 52, wherein the information transmitted to the at least one other radio node for triggering the activation or the deactivation of one or more AI and/or ML models indicates at least two AI and/or ML models to be activated during a duration of time for comparison of model performance.

59. The method of claim 54, wherein the second radio node is a base station or a UE, or wherein the at least one other radio node includes a UE or a base station.

60. A first radio node adapted to:
transmit, to a second radio node, information indicating an activation or a deactivation of one or more Artificial Intelligence (AI) and/or Machine Learning (ML) models at the first radio node.

61. The first radio node of claim 60, wherein the first radio node is adapted to, prior to transmitting the information indicating the activation or deactivation of the one or more AI and/or ML models, receive, from the second radio node, information triggering the activation or the deactivation of the one or more AI and/or ML models at the first radio node.

62. A second radio node adapted to:
transmit, to at least one other radio node, information for triggering an activation or a deactivation of one or more Artificial Intelligence, AI, and/or Machine Learning, ML, models for implementation at the at least one other radio node.

63. The second radio node of claim 62, wherein the second radio node is adapted to receive, from the at least one other radio node, information indicating the activation or the deactivation of the one or more AI and/or ML models at the at least one other radio node.
